(19) United States
(12) Patent Application Publication
(10) Pub. No.: US 2012/0209760 A1
(43) Pub. Date: Aug. 16, 2012

(54) RISK IDENTIFICATION SYSTEM AND JUDGMENTAL REVIEW INTERFACE

(75) Inventors: Timothy C. McCarthy, O'Fallon, MO (US); Thomas Anderson, Clover, SC (US); Carmie Cheatham, Tampa, FL (US); Sharon R. Connelly, San Anselmo, CA (US); Patricia A. Cordes, Jacksonville, FL (US); Patricia Hanson, Garland, TX (US); Steven F. Justice, Marlborough, MA (US); Julie C. Murphy, Charlotte, NC (US); Christine L. Pryor, Lynn, MA (US); Brian J. Valetutti, Elkton, MD (US); Laurel A. Watson, Dallas, NC (US)

(73) Assignee: BANK OF AMERICA CORPORATION, Charlotte, NC (US)

(21) Appl. No.: 13/027,664

(22) Filed: Feb. 15, 2011

(51) Int. Cl. G06Q 40/00

(52) U.S. Cl. 705/38

(57) ABSTRACT

Embodiments of the invention are directed to systems, methods and computer program products for identifying one or more risk patterns for an account based on a plurality of rules, determining whether to add an account on to a judgmental review queue based at least in part on the one or more risk patterns identified for the account, and allowing a user to execute one or more risk mitigation actions for the account in order to curb possible financial losses that may result from the identified risk patterns.

### BACKGROUND

Risk may be defined in a business environment as an event, situation, or condition that may occur and, if it occurs, will impact the ability of a business to achieve its desired objectives. Risk management involves: (1) defining events, situations, or conditions and the potential impact to the business, clients, and/or the like; (2) detecting those defined events when they occur; (3) executing a pre-defined set of actions to minimize negative impacts based upon the level of threat and client impact of mitigation alternatives (e.g., risk mitigation, prevention and the like); and (4) when unable to prevent a risk event from negatively impacting, executing a set of actions to recover all or part of the loss. In some cases, recovery includes taking legal action against the entity causing the loss.

In the financial world, risk management is necessary in various aspects of the business. Financial institutions manage various forms of risk. One such risk is credit risk, which is a risk related to the inability of a client, customer, or other party to meet its repayment or delivery obligations under previously agreed upon terms and conditions around credit (e.g., a loan, a line of credit, or the like) provided to the party. Credit risk can also arise from operational failures that result in an advance being provided to a customer that should not be advanced the funds.

A financial institution may suffer losses when a client's repayment obligation is overdue. A financial institution may also suffer losses when a client, as part of its repayment obligation, makes a payment that cannot be collected. For instance, the client may issue a bad check either fraudulently or inadvertently because of clerical error. Worse still is when the client issues a bad check and the financial institution provides new credit to the client in reliance on the client's check.

Current risk identification processes are manual in nature. Account data for several accounts are usually stored in one or more spreadsheets, and a person at a financial institution makes a determination on the riskiness associated with an account after reviewing the account data in the spreadsheet. That person may then record his or her risk determination, observation, or recommendation in the spreadsheet. That person may also manually execute a risk mitigation action if an account is determined to be too risky.

For all these reasons and others, there is a need for a financial institution to devise a system to identify clients, accounts, or transactions that may fit risk patterns which may result in financial losses. There is a need to better organize and present account data associated with an account to a person at a financial institution who determines and executes appropriate risk mitigation action based on the presented account data.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention address the above needs and/or achieve other advantages by providing apparatuses (e.g., a system, computer program product, and/or other device), methods, or a combination of the foregoing for identifying one or more risk patterns for accounts at a financial institution based on a plurality of rules, and allowing a user at the financial institution to execute risk mitigation actions or routines for those accounts for which risk patterns have been identified. The risk mitigation actions may mitigate the financial losses that may result from the identified risk patterns.

For example, some embodiments of the invention provide a method for risk identification and mitigation. The method includes periodically receiving account data for an account. The method additionally includes identifying a risk pattern associated with the account. The method additionally includes, in response to identifying a risk pattern associated with an account, determining whether the account was reviewed by a user within a pre-determined period of time in the past. The method additionally includes, in response to determining that the account was not reviewed by a user within the pre-determined period of time in the past, adding the account to a judgmental review queue.

In some embodiments, the method additionally includes presenting to a user account data associated with the account. The method additionally includes allowing the user to determine whether a risk mitigation action needs to be executed on the account. The method additionally includes allowing the user to determine the type of risk mitigation action to be executed on the account.

In some embodiments, identifying a risk pattern includes determining whether the account is delinquent, wherein the account is delinquent if a payment on the account has been due for a pre-determined period of time. In some embodiments, identifying a risk pattern includes determining whether a risk mitigation action was executed on the account within a pre-determined period in the past. In some embodiments, identifying a risk pattern includes accessing a second account associated with the account; and determining whether the second account is delinquent, wherein the second account is delinquent if a payment on the second account has been due for a pre-determined period of time. In some embodiments, identifying a risk pattern includes accessing a business bureau report associated with the account, and determining whether there is a derogatory event in the business bureau report. In some embodiments, identifying a risk pattern includes accessing a consumer bureau report associated with the account, and determining whether there is a derogatory event in the consumer bureau report. In some embodiments, identifying a risk pattern includes determining a risk score associated with the identified risk pattern, determining a rating associated with the identified risk pattern based at least in part on the risk score, and determining whether the rating associated with the identified risk pattern is favorable.

In some embodiments, presenting account data to a user further comprises pictorially presenting a risk score associated with the account, wherein the risk score is generated based on the one or more risk patterns identified for the account. In some embodiments, presenting account data to a user further comprises pictorially presenting a risk rating associated with the identified risk patterns. In one embodiment, a rating associated with the identified risk pattern may be a risk color. In some embodiments, presenting account data to a user further comprises presenting account data associated with the account, presenting the one or more risk patterns identified for the account, and presenting one or more suggested risk mitigation actions for the account, based at least in part on the one or more risk patterns identified for the account.

In some embodiments, the risk mitigation action comprises placing a hold on a payment made to the account. In some embodiments, the risk mitigation action comprises decreasing a line of credit associated with the account. In some embodiments, the risk mitigation action comprises closing a line of credit associated with the account. In some embodiments, the risk mitigation action comprises blocking access of an account to a user associated with the account, wherein the blocked account cannot participate in or more transactions. In some embodiments, the risk mitigation action comprises forcing a holder of the account to comply with a financial obligation associated with the account.

Each of the above embodiments of the method is executed via a computing device processor.

Embodiments of the invention also provide an apparatus for risk identification and mitigation. The apparatus includes a computing platform including at least one processor and a memory. The apparatus also includes a module, or more than one module, stored in the memory, executable by the processor, and configured to execute the various embodiments of the method described above.

Embodiments of the invention also provide a computer program product for risk identification and mitigation. The computer program product includes a non-transitory computer-readable medium including a set of codes for causing a computer to execute the various embodiments of the method described above.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a block diagram illustrating a computer network environment, in accordance with an embodiment of the invention;

FIG. 2 is a block diagram of a system configured to identify risk patterns, present account data to a user, and allow a user to execute risk mitigation actions, in accordance with embodiments of the present invention;

FIG. 3 is a flowchart for identifying risk patterns associated with an account, presenting data associated with the account, and allowing a user to execute risk mitigation actions on the account, in accordance with embodiments of the present invention;

FIG. 4 is a flowchart displaying a method for identifying risk patterns associated with an account, in accordance with embodiments of the present invention;

FIGS. 5-10 are illustrations of a graphical user interface used during the process of FIG. 3, in accordance with embodiments of the present invention; and

FIG. 11 is a block diagram illustrating the user's workstation of FIG. 1, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

In general, embodiments of the present invention relate to systems, methods and computer program products for identifying one or more risk patterns for an account based on a plurality of rules, determining whether to add an account on to a judgmental review queue based at least in part on the one or more risk patterns identified for the account, and allowing a user to execute one or more risk mitigation actions or routines for the account in order to curb possible financial losses that may result from the identified risk patterns.

For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. An “account” may be the relationship that an individual or a first entity such as a business organization, hereinafter referred to as the “client” or “account holder”, has with a second entity, which may be a financial institution. This account may be a credit account such that the account holder has a repayment or delivery obligation towards a second entity under previously agreed upon terms and conditions. In one embodiment, the account may be associated with a product that is unsecured. In another embodiment, the account may be associated with a product that is secured. A “transaction” may be monetary in nature (e.g., a purchase via a credit card; depositing a check in an account; requesting a credit or cash advance; a stock trade or the like) or non-monetary in nature (e.g., a telephone call; an encounter with a financial institution or non-financial institution associate/representative; an identity authentication process, such as a biometric identity authentication process; recorded use of a utility, such as electricity and the like).

In accordance with embodiments of the invention, the term “module” with respect to a system may refer to a hardware component of the system, a software component of the system, or a component of the system that comprises both hardware and software.

A risk rating may be metric to measure risk or an indicator of the amount of risk associated with an account. In one embodiment, a risk rating may be based on a risk score, wherein the score may be standardized on a fixed scale, such as a scale from 1 to 100. Therefore, for example, a risk rating of ‘1’ or ‘A’ may correspond with risk scores from 70 to 100, a risk rating of ‘2’ or ‘B’ may correspond with risk scores from 30 to 70, and a risk rating of ‘3’ or ‘C’ may correspond with risk scores from 0 to 30. In other embodiments, a risk rating may include a risk color, risk rank, or the like. Therefore, in accordance with embodiments of the invention, the term “color” may refer to a type of “rating.”

The plurality of rules for identifying risks may be executed using financial institution data and non-financial institution data. The financial institution data may include transactional level data, such as checking transactions, ATM transactions, and credit/debit card transactions that allow for determination of a an account holder's transactional behaviors. Additionally, the financial institution data may include account data, such as account balances and the like, and account holder data, such as personal data, profile data, demographics data, contact information, and the like. More specifically, the financial institution data may include the age of the account, payment history, payment terms, payment sizes of both current and past payments, payment sources of both current and past payments, payment due dates and whether the account holder is meeting the payment due dates, the number of days overdue if a payment is overdue, whether any past payments have been returned for any reason other than error on part of the financial institution that holds the account, the type of loan product associated with the account, whether the loan product is unsecured or secured, the guarantors of an account, whether any risk mitigation actions have previously been executed on the account, payment history of other associated accounts, any remarks associated with the account or associated accounts, etc. In addition, data may be collected from non-financial institutions, such as consumer bureaus, business bureaus, retailers (online and brick & mortar) government agencies, Internet Service Providers (ISPs), telephone companies (Telcos), health care industry entities, and the like. The information obtained from consumer bureaus may include payment status on bills, payment status on accounts at other financial institutions, credit utilization ratios, length and variety of credit history, instances of credit inquiries, instances of charge-offs, instances of bankruptcy filings, instances of other delinquencies, or the like. The information from business bureaus may include bankruptcy filings, payment disputes with customers, payment of dues to business bureaus, information provided to business bureaus or the like. The non-financial information may provide additional transactional information regarding the holder of an account, such as the type of business or operation that the account holder is engaged in, the reputation of the account holder, etc. If the account holder is an individual, the non-financial information may include the type of items purchased and the like, behavioral data, such as purchasing or browsing behaviors, etc. The financial institution data and non-financial institution data may be captured in one or more risk databases that allow for analytics and/or logic to be performed on the data for the purpose of leveraging the collected data to define various risk patterns and execute various routines/logic to mitigate the risks associated with identified risk patterns.

### Network Environment

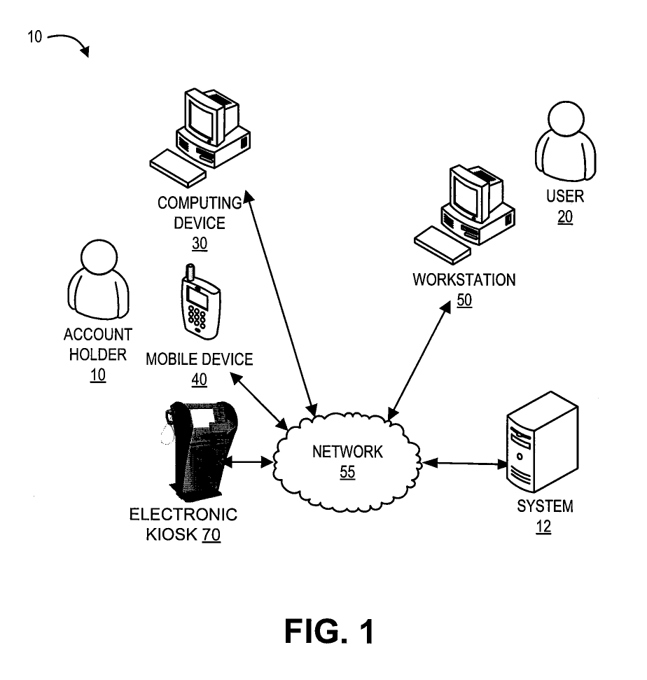

FIG. 1 provides a block diagram illustrating a computer network environment 10 configured to identify risk patterns, present account data to a user, allow the user to execute risk mitigation actions or routines on an account, and allow an account holder to perform one more transactions with an account, in accordance with embodiments of the present invention. As illustrated in FIG. 1, the computer network environment 10 may include a computing device 30 (or a mobile device 40 or an electronic kiosk 70) operable by an account holder 10 and a workstation 50 operable by a user 20 associated with a financial institution. The computing device 30 and the workstation 50 may be in electronic communication with a system 12 via a network 55, which may be the Internet, an intranet or the like. Additionally, the computer network environment 10 includes the system 12 configured to identify risk patterns associated with accounts accessed by the system 12, present account data to the user 20, allow the user 20 to execute risk mitigation actions or routines on an account, and allow the account holder 10 to perform one more transactions with an account.

### System Environment

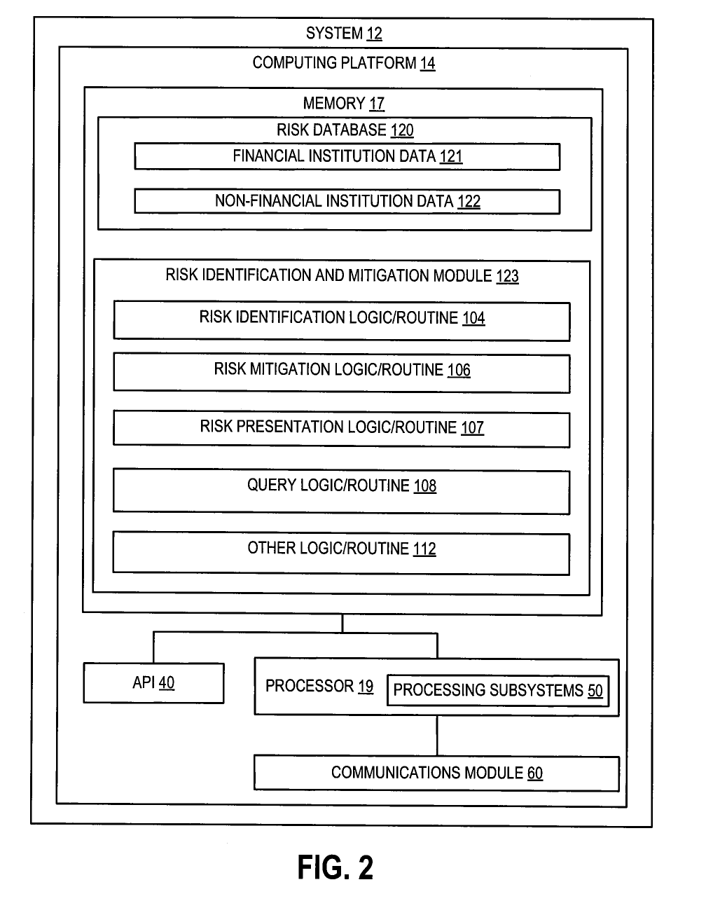

FIG. 2 is a block diagram of a system 12 configured to identify risk patterns, present account data to a user, and allow the user to execute risk mitigation actions or routines on an account, in accordance with embodiments of the present invention. The system 12 may include a computing platform 14 having a memory 17 and at least one processor 19 that is in communication with the memory 17. The memory 17 may comprise volatile and non-volatile memory, such as read-only and/or random-access memory (RAM and ROM), EPROM, EEPROM, flash cards, or any memory common to computer platforms. Further, the memory 17 may include one or more flash memory cells, or may be any secondary or tertiary storage device, such as magnetic media, optical media, tape, or soft or hard disk.

The processor 19 may be an application-specific integrated circuit (“ASIC”), or other chipset, processor, logic circuit, or other data processing device. The processor 19 or other processor such as ASIC may execute an application programming interface (“API”) 40 that interfaces with any resident programs, such as the risk identification and mitigation module 123 and related applications/routines and/or logic or the like stored in the memory 17 of the system 12.

The processor 19 may include various processing subsystems 50 embodied in hardware, firmware, software, and combinations thereof, that enable the functionality of the system 12 and the operability of the system 12 on a network. For example, the processing subsystems 50 may allow for initiating and maintaining communications and exchanging data with other networked devices. The processing subsystems 50 of processor 19 may include any subsystem used in conjunction with the risk identification and mitigation module 123 or the like or subcomponents or sub-modules thereof.

The system 12 may additionally include a communications module 60 embodied in hardware, firmware, software, and combinations thereof, that enables communications among the various components of the system 12, as well as between the other devices in the network. Thus, the communications module 60 may include the requisite hardware, firmware, software and/or combinations thereof for establishing a network communication connection. It should be appreciated that the communications module 60 may be the mechanism through which users submit queries to the system 12. It should also be appreciated that the communications module 60 may be the mechanism through which embodiments of the present invention sends alerts, reports, scores, data, files, or the like to configured users, account holders, systems, and the like. It should also be appreciated that the communications module 60 may be the mechanism through which embodiments of the present invention initiate presentation of account data to one or more users. It should also be appreciated that the communications module 60 may be the mechanism through which embodiments of the present invention may allow a user to input instructions into the system 12 to execute certain risk mitigation actions or perform other actions on an account, including adding remarks on an account, manually overriding certain automated or non-automated risk mitigation actions previously executed on an account, etc.

The memory 17 may include a risk identification and mitigation module 123 that is executable by the processor 19. The risk identification and mitigation module 123 may receive or access financial institution data 121 and/or non-financial institution data 122 that may be a collected at a risk database 120. The risk database 120 may be a centralized database or it may represent one or more remote databases. The financial institution data 121 and non-financial institution data 122 have been described earlier. In one embodiment, the risk identification and mitigation module 123 may also receive or access risk identification rules, which may be collected at a centralized rules database or at one or more remote rules databases.

The risk identification and mitigation module 123 may include a plurality of logic/routines configured to identify risk patterns and mitigate the identified risks based on the use of the data collected in the risk database 120 and accessible by the risk identification and mitigation module 123. The logic/routines shown in FIG. 2 are by way of example only and, as such, risk identification and mitigation module 123 may include more or less logic/routines as dictated by the implementation of the system 12.

As stated earlier, the memory 17 may store a risk identification and mitigation module 123. In specific embodiments, the risk identification and mitigation module 123 may comprise a risk identification logic/routine 104 that is configured to identify one or more risk patterns associated with an account, such as a credit account. In one embodiment, the risk identification and mitigation module 123 may even comprise a risk identification logic/routine 104 that is automatically configured to identify one or more risk patterns associated with an account. The risk identification logic/routine 104 may access one or more risk identification rules. The risk identification rules may be integrated into the risk pattern identification logic/routine 104 or the risk identification rules may be accessed from a separate rules database. The risk identification logic/routine 104 may include logic or routines based on a variety of rules to identify risk patterns associated with an account. For instance, the risk identification logic/routine 104 may identify a risk pattern when an account is delinquent, wherein the account is delinquent if a payment on the account has been due for a pre-determined period of time. The risk identification logic/routine 104 may also identify a risk pattern when another account associated with the account under consideration is delinquent. The risk identification logic/routine 104 may also identify a risk pattern when a risk mitigation action was executed on the account within a pre-determined period of time in the recent past. The risk identification logic/routine 104 may also identify a risk pattern when a derogatory event is detected in a business bureau report associated with the account or the account holder. The risk identification logic/routine 104 may also identify a risk pattern when a derogatory event is detected in a business bureau report associated with the account or the account holder.

The risk identification logic/routine 104 may also be configured to automatically generate a risk score based at least in part on one or more of the risk patterns that were identified for the account. The risk identification logic/routine 104 may also be configured to automatically generate a risk rating based at least in part on the risk score.

In order to determine whether to add the account under consideration to a judgmental review queue, the risk identification and mitigation module 123 may be configured to determine whether the risk score is above a pre-determined risk threshold score, or whether the risk rating is a favorable rating. In one embodiment, the risk rating is favorable when the risk score is above a pre-determined threshold score.

In one embodiment, the judgmental review queue is a queue that comprises accounts that are presented to a user in order for a user to conduct a judgmental review of each account on the queue. As used herein, a “user” is an analyst at a financial institution that reviews accounts. In some embodiments, the user is a human, while in other embodiments, the user may be a computer. As used herein, a judgmental review may be an analysis of an account by one or more users. In some embodiments, a judgmental review may be a holistic analysis of the account, wherein the user not only considers account data presented by the system 12 but may also consider other data associated with the account or account holder obtained from other external sources. In some embodiments, there may be more than one judgmental review queues, and an account may be placed on one or more judgmental review queues. Each judgmental review queue may comprise accounts that are associated with similar identified risk patterns and may be reviewed by a user who has expertise in reviewing accounts associated with the identified type of risk patterns.

In specific embodiments, the risk identification and mitigation module 123 may comprise a risk mitigation logic/routine 106 that is executed for one or more accounts on the judgmental review queue. The risk identification and mitigation module 123 may be configured to automatically execute a risk mitigation logic/routine 106 in response to identifying one or more risk patterns associated with an account. In another embodiment, the risk identification and mitigation module 123 may be configured to allow a user to execute, via a computing device processor, a risk mitigation logic/routine 106.

The risk mitigation logic/routine 106 may include logic or routines to automatically place or allow a user to place a hold on a payment made to the account, automatically decrease or allow a user to decrease a line of credit associated with the account, automatically close or allow a user to close a line of credit associated with the account, automatically block or allow a user to block access of an account to a user associated with the account, wherein the blocked account cannot participate in one or more transactions, automatically hold or allow a user to hold a payment made to an account, etc. The risk identification and mitigation module 123 may include other logic/routine 112 that perform additional risk monitoring, risk identification, risk mitigation, risk presentation, risk alerting, or other supporting functions.

In specific embodiments, the risk identification and mitigation module 123 may comprise a risk presentation logic/routine 107. The risk presentation logic/routine 107 may be configured to communicate to a user, account data for accounts that are added to the above-described judgment review queue. Additionally, the risk presentation logic/routine 107 may also be configured to communicate to one or more users, risk identification alerts generated by the risk identification logic/routine 104. The risk alert logic/routine 107 may also be configured to communicate notifications about risk mitigation actions executed on an account to other users or the account holders. The risk presentation logic/routine 107 may be configured to present account data associated with an account to a user. The risk presentation logic/routine 107 may also be configured to receive instructions from a user to execute certain risk mitigation actions or perform other actions on an account, including adding remarks on an account, manually overriding certain automated or non-automated risk mitigation actions previously executed on an account, etc.

The query logic/routine 108 may be configured to receive a query from a user to allow the user to query an account to determine whether the account meets the criteria for any selected risk pattern. The query logic/routine 108 may also be configured to communicate the results of the query to an appropriate recipient. The risk alerts and query responses may be communicated via the communications module 60 which may invoke a communication channel, such as letter, email, Short Message Service (SMS)/text, voicemail or the like. In many instances the query responses and/or risk alerts may be configured to be communicated electronically either in real-time, near-real-time or periodic batch files to personnel, systems, databases, or the like. The query logic/routine 108 may be useful when a user analyzes other accounts associated with the account under consideration.

### Risk Identification and Judgmental Review Process Flow

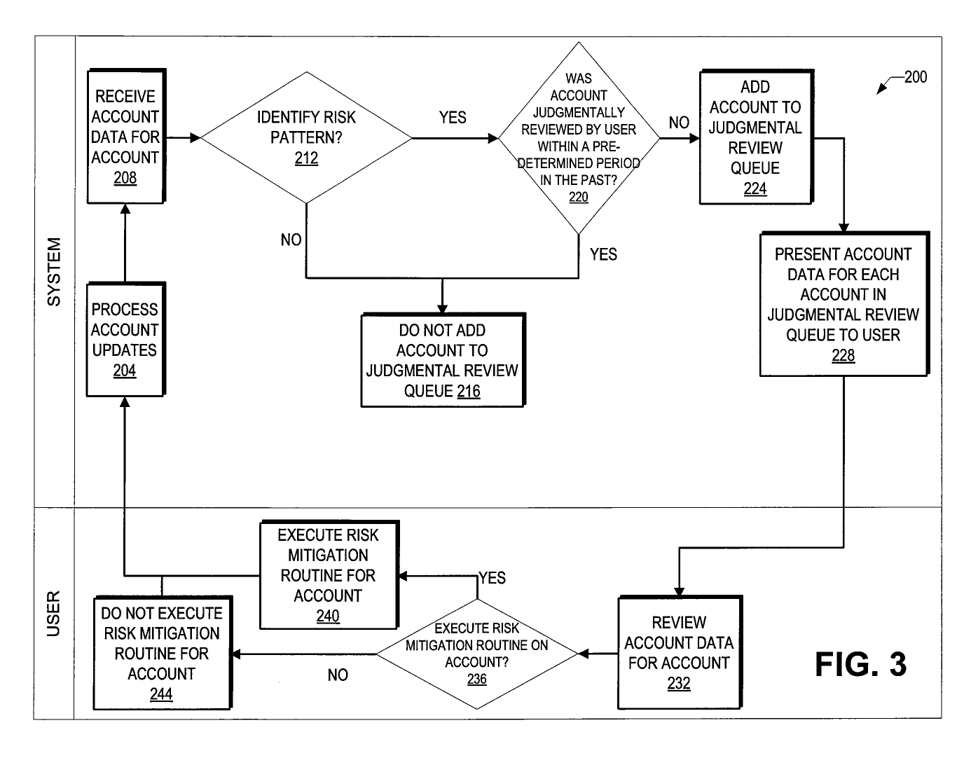

FIG. 3 is a detailed flowchart displaying a risk identification and mitigation method 200, in accordance with embodiments of the present invention. FIG. 3 illustrates the flow chart in terms of “swim lanes” associated with entities which may perform the operations in each respective swim lane. The entities illustrated in the exemplary Figure are (1) a system, such as a computing system, and (2) a user of the system. However, it should be noted that other entities could also be involved and some embodiments of the invention may not be limited to the entities illustrated in FIG. 3. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process starts at block 204 where, in one embodiment, the system 12 may periodically process account updates in a batch processing environment. Account updates may include a payment being made to an account or an advance being requested from an account. An advance may be a credit advance or a cash advance. Account updates may also include a risk mitigation action executed on an account by a user. Account updates may also include user input that directs the system to override a risk mitigation action previously executed on an account by a user. In a batch processing embodiment, the system may periodically update accounts once, or a fixed number of times, during a pre-determined period, such as a day, based on all the account data that was received throughout the pre-determined period. In one embodiment, the system may be able to identify and select one or more accounts to exclude from the periodic account updates. Therefore, in such an embodiment, these excluded accounts may be excluded from the risk identification process as described below. Subsequently, the system may also produce any output files, such as account alerts or the like, that may result from updating the accounts. In one embodiment, the system may dynamically process account updates. In this embodiment, the system may dynamically update a particular account when it receives data associated with that particular account.

The process then moves to block 208 of FIG. 3, where the system, in one embodiment of the invention, may access data associated with various accounts that are stored in a database, which is accessible by the system. In one embodiment, the system, may only access those accounts that have been updated in block 204. In one embodiment, the system may itself store the accounts. In one embodiment, these accounts may be credit accounts such that the account holders associated with the accounts have repayment or delivery obligations where both principal and interest on the principal may be due under previously agreed upon terms and conditions. In one embodiment, the data associated with an account may include the previously described data that may be used to identify various risk patterns. For instance, the data may include the balance on the account, the status of the account, the length of any delinquency or overdue payment, the guarantors of an account, etc.

### Risk Identification Process Flow

The process moves to block 212 of FIG. 3, where the system, in one embodiment, may automatically identify, via a computing device processor, one more risk patterns associated with the account under consideration. In another embodiment, a user of the system may determine whether a risk pattern exists for an account under consideration.

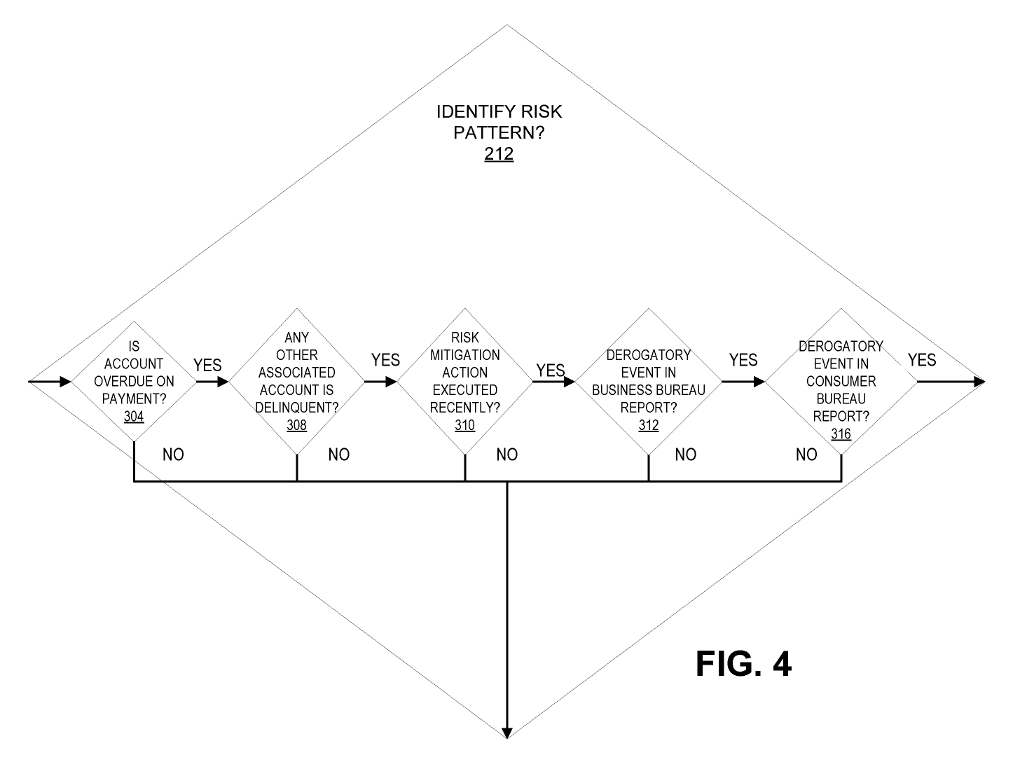

As shown in FIG. 4, the process path for identifying each type of risk pattern in FIG. 4 may be executed by the system in a serial manner, i.e., the system checks for one type of risk pattern before checking for a second type of risk pattern. The serial path presented in FIG. 4 is one instance of a serial path for identifying risk patterns. In other embodiments, the serial path for identifying risk patterns may differ from that presented in FIG. 4. For instance, block 310 may precede block 304, or block 312 may precede block 310, etc. In another embodiment, the process path for identifying one type of risk pattern may run parallel to and may be mutually exclusive of the process path for identifying a second type of risk pattern.

As shown in FIG. 4, block 212 comprises of several other blocks. In one embodiment, the process of identifying a risk pattern may comprise determining whether an account is delinquent at block 304 of FIG. 4. In one embodiment, the account principal may be delinquent. In another embodiment, the interest due on the account may be delinquent. In one embodiment, the system may determine that the account is delinquent if a payment on the account has been due for a pre-determined period of time. In one embodiment, the pre-determined period of time may be set by a user of the system. In one embodiment, the pre-determined period of time may be determined dynamically for an account such that the pre-determined period of time for one account is different from the pre-determined number of days for another account.

In one embodiment, if the system determines that the account is not delinquent, the account is not added to a judgmental review queue. In one embodiment, if the system determines that the account is delinquent, the account is directly added to a judgmental review queue. In one embodiment, if the system determines that the account is delinquent, the system considers this delinquency when it identifies a risk pattern associated with the account at block 212 of FIG. 3.

As shown in FIG. 4, the process may move to block 308 where the process of identifying a risk pattern may comprise determining whether any other account associated with the account under consideration or the account holder is delinquent, wherein the conditions for delinquency have been previously described. For instance, the other account may be an installment account, a revolving account, a mortgage account, a consumer finance account, or the like associated with the same account holder as the account under consideration. These other accounts may be accounts at the same financial institution that holds the account under consideration.

In one embodiment, if the system determines that one or more of the other associated accounts are not delinquent, the account under consideration is not added to a judgmental review queue. In one embodiment, if the system determines that one or more of the other accounts are delinquent, the account is directly added to a judgmental review queue. In one embodiment, if the system determines that one or more of the other accounts are delinquent, the system considers this factor when it identifies a risk pattern associated with the account at block 212 of FIG. 3.

As shown in FIG. 4, the process may move to block 310 where the process of identifying a risk pattern may comprise determining whether a risk mitigation action was executed within a pre-determined period of time in the recent past on the account. In one embodiment, the system may identify a risk pattern if certain risk mitigation actions were executed on the account within a pre-determined period of time in the recent past. For instance, the system may identify a risk pattern if a credit line associated with an account was decreased by more than 10% in the previous six months. In another embodiment, the system may identify a risk pattern if a risk mitigation action was executed by a user from a certain department of the financial institution. For instance, in one embodiment, a risk pattern may be triggered if a user from a small business department of the financial institution executed a risk mitigation action on the account.

In one embodiment, the pre-determined period of time within which a risk mitigation action was previously executed may be set by a user of the system. In one embodiment, the pre-determined period of time may be determined dynamically for an account such that the pre-determined period of time for one account is different from the pre-determined number of days for another account.

In one embodiment, if the system determines that a risk mitigation action was not executed on the account within a pre-determined period of time in the past, the account is not added to a judgmental review queue. In one embodiment, if the system determines that a risk mitigation action was executed on the account within a pre-determined period of time in the past, the account is directly added to a judgmental review queue. In one embodiment, if the system determines that a risk mitigation action was executed on the account within a pre-determined period of time in the past, the system considers this factor when it identifies a risk pattern associated with the account at block 212 of FIG. 3.

In an alternate embodiment, the system may not identify a risk pattern if a risk mitigation action that addresses the identified risk pattern was executed on an account within a pre-determined period of time in the past. In one embodiment, the system may not identify a risk pattern if any risk mitigation action was executed on an account within a pre-determined period in the past. In such an embodiment, the system may not identify a risk pattern because a risk mitigation action was already executed on the account, and adding the account to a judgmental review queue may be a waste of resources since the account was already acted upon recently.

As shown in FIG. 4, the process may move to block 312 where the process of identifying a risk pattern may comprise accessing a business bureau report associated with the account or the holder of the account and determining whether there is derogatory event in the business bureau report within a pre-determined period of time in the past. In one embodiment the system may automatically access a business bureau report from one or more business bureaus. In one embodiment, the system may allow a user of the system to access a business bureau report from one or more business bureaus. In still another embodiment, a user may independently access a business bureau report from one or more business bureaus through one or more other systems. In one embodiment, block 312 may not even be executed as part of block 212; instead, a user may access a business bureau report from one or more business bureaus as part of block 232 where the user judgmentally reviews account data for an account on the judgmental review queue.

In one embodiment, the system may automatically determine whether there is a derogatory event in the business bureau report. In another embodiment, a user of the system may determine whether there is a derogatory event in the business bureau report. The financial institution may set one or more rules to define what constitutes a derogatory event in the business bureau report. These rules may be coded into the risk identification logic/routine that has been described earlier. For instance, a bankruptcy filing by the account holder might be a derogatory event. As a further instance, a payment dispute with more than a certain threshold of customers, e.g., 100 customers, over the same or a similar matter, may serve as another derogatory event. As a further instance, non-payment of dues to one or more business bureaus may serve as another derogatory event. As a further instance, in some situations, a failure to provide information to one or more business bureaus that is requested by the one or more business bureaus may serve as another derogatory event. As a further instance, a reported misrepresentation in advertising may serve as another derogatory event. The type of derogatory events are not limited the events described here. There may be other derogatory events that are not described here. Some of the above events may require a user of the system to determine whether the events are derogatory events.

In one embodiment, the pre-determined period of time within which the derogatory event occurred or was reported may be set by a user of the system. In one embodiment, the pre-determined period of time within which the derogatory event occurred or was reported may be determined dynamically for an account such that the pre-determined period of time for one account is different from the pre-determined number of days for another account.

In one embodiment, if the system determines that a derogatory event is not identified in one or more business bureau reports within a pre-determined period of time in the past, the account may not be added to a judgmental review queue. In one embodiment, if the system determines that a derogatory event is identified in one or more business bureau reports within a pre-determined period of time in the past, the account may be directly added to a judgmental review queue. In one embodiment, if the system determines that a derogatory event is identified in one or more business bureau reports within a pre-determined period of time in the past, the system may consider this factor when it identifies a risk pattern associated with the account at block 212 of FIG. 3.

As shown in FIG. 4, the process may move to block 316 where the process of identifying a risk pattern may comprise accessing a consumer bureau report associated with the account or the holder of the account and determining whether there is derogatory event in the consumer bureau report within a pre-determined period of time in the past. In one embodiment the system may automatically access a consumer bureau report from one or more consumer bureaus. In some embodiments, a consumer report has defined herein may be a credit report associated with the account under consideration or associated with a holder of the account under consideration. In one embodiment, the system may allow a user of the system to access a consumer bureau report from one or more consumer bureaus. In still another embodiment, a user may independently access a consumer bureau report from one or more business bureaus through one or more other systems. In one embodiment, block 316 may not even be executed as part of block 212; instead, a user may access a consumer bureau report from one or more consumer bureaus as part of block 232 where the user judgmentally reviews account data for an account on the judgmental review queue.

In one embodiment, the system may automatically determine whether there is a derogatory event in the consumer bureau report. In another embodiment, a user of the system may determine whether there is a derogatory event in the consumer bureau report. The financial institution may set one or more rules to define what constitutes a derogatory event in the consumer bureau report. These rules may be coded into the risk identification logic/routine that has been described earlier. For instance, a late payment on an account at another financial institution or other entity that is reported on a consumer bureau report may be classified as a derogatory event. As a further instance, a late payment on a bill that is reported on a consumer bureau report may also be classified as a derogatory event. As a further instance, a high credit utilization ratio reported on a consumer bureau report may also be classified as a derogatory event, wherein the credit utilization ratio is the ratio of current credit balance to the total available credit limit. In some instances, a credit history shorter than a predetermined threshold period of time reported on a consumer bureau report may also be classified as a derogatory event. In some instances, if the holder of the account under consideration has not managed several different types of credit, that factor may also be classified as a derogatory event. In some instances, a credit inquiry made by certain types of entities as reported on a consumer bureau report may also be classified as a derogatory event. In some instances, a charge-off, a bankruptcy filing, or other delinquencies that are reported on a consumer bureau report may also be classified as derogatory events. The type of derogatory events are not limited the events described here. There may be other derogatory events that are not described here. Some of the above events may require a user of the system to determine whether the events are derogatory events.

In one embodiment, the pre-determined period of time within which the derogatory event occurred or was reported may be set by a user of the system. In one embodiment, the pre-determined period of time within which the derogatory event occurred or was reported may be determined dynamically for an account such that the pre-determined period of time for one account is different from the pre-determined number of days for another account.

In one embodiment, if the system determines that a derogatory event is not identified in one or more consumer bureau reports within a pre-determined period of time in the past, the account may not be added to a judgmental review queue. In one embodiment, if the system determines that a derogatory event is identified in one or more consumer bureau reports within a pre-determined period of time in the past, the account may be directly added to a judgmental review queue. In one embodiment, if the system determines that a derogatory event is identified in one or more consumer bureau reports within a pre-determined period of time in the past, the system may consider this factor when it identifies a risk pattern associated with the account at block 212 of FIG. 3.

In other embodiments, the system may access other credit or audit data from others sources to determine whether a risk pattern exists for an account under consideration.

The type of risk patterns that may be identified by the system or a user of the system may not be limited to the risk patterns described above. For instance, in some embodiments, a risk pattern may be identified for an account when there is a delay in collecting a payment made to the account.

In some embodiments, the system may be configured to identify a risk pattern based on the source of the payment. In one instance, if the system determines that the payment source account is an account at the same financial institution that manages the system, then the system may be able to verify if there are sufficient funds in the source account. If there are sufficient funds in the source account, the system may not identify a risk pattern. If there are insufficient funds in the source account, the system may identify a risk pattern. In another instance, if the system determines that the payment source account is not an account at the same financial institution that manages the system, the system may identify a risk pattern if the payment made to the account has not yet been collected after a pre-determined period of time.

In some embodiments, the system may be configured to determine how the size of a current payment made compares to sizes of payments made during a pre-determined period in the past. If the payment size is similar to sizes of payments made in the past, the system may not identify a risk pattern. If the payment size is larger by a pre-determined percentage amount than sizes of payments made in the past, then the system may identify a risk pattern.

In some embodiments, the system may also consider the period of time for which the account has been open in determining whether a risk pattern exists. In some embodiments, the system may also consider the financial obligation remaining on the account in determining whether a risk pattern exists. In some embodiments, the system may also consider the total of all payments made on the account. In some embodiments, the system may also consider the number of payments made on time during a pre-determined period of time in the past and the number of payments not made on time during a pre-determined period in the past. In some embodiments, the system may also consider how soon after a due date a payment was made on one or more occasions during a pre-determined period in the past. In some embodiments, the system may also consider the size of the largest or smallest payments made during a pre-determined period in the past, and how those payments compare to the current payment. In some embodiments, the system may also consider the number of payments returned for any reason other than error on the part of the financial institution during a pre-determined period in the past. In some embodiments, the system may also consider whether the loan or product associated with the account under consideration is secured or unsecured.

### Judgmental Review Process Flow

In some embodiments, the process flow moves to block 220 if a single risk pattern is identified for an account at block 212 of FIG. 3. If the system determines that a risk pattern is not identified for an account at block 212, the account under consideration may not be added to a judgmental review queue as indicated at block 216. However, in some embodiments, even if a risk pattern is not identified for an account, the account under consideration may be added to a judgmental review queue either by the system or a user of the system.

In other embodiments, if one or more risk patterns are identified at block 212 of FIG. 3, the system may compute a score based at least in part on each of the identified risk patterns. In some embodiments, the process flow may move to block 220 if the computed score is greater than a pre-determined score. In some embodiments, the account under consideration may not be added to a judgmental review queue if the computed score is smaller than a pre-determined score.

Therefore if the system identifies a risk pattern at block 212 of FIG. 3, the process flow may move to block 220 where the system determines whether the account under consideration was judgmentally reviewed by a user of the system within a pre-determined period of time in the past. As indicated below, a judgmental review is an analysis of the account by one or more users of the system.

If the system determines that the account was judgmentally reviewed by a user of the system within a pre-determined period of time in the past, the account may not be added to a judgmental review queue, as indicated by block 216 of FIG. 3. This is because since a judgmental review was already undertaken on the account within a pre-determined period of time in the past, it would be a waste of human resources, i.e., users' time and effort, to judgmentally review the account again. The same human resources may then be used to judgmentally review other accounts on a judgmental review queue that have not been previously reviewed. Therefore, if the system determines that the account was judgmentally reviewed by a user within a pre-determined period of time in the past, the account may not be added to a judgmental review queue, regardless of whether or not a risk mitigation action was executed on the account during a previous instance of a judgmental review of the account. In some embodiments, even if an account was judgmentally reviewed by a user of the system within a pre-determined period of time in the past, the account may still be added be a judgmental review queue.

As indicted in FIG. 3, if the system determines that the account was not judgmentally reviewed by a user of the system within a pre-determined period of time in the past, the system may add the account to a judgmental review queue at block 224 of FIG. 3. As indicated above, in one embodiment, a judgmental review queue is a queue that comprises accounts that are presented to a user in order for a user to conduct a judgmental review of each account on the queue. In some embodiments, there may be more than one judgmental review queue, and an account may be placed on one or more judgmental review queues. In one embodiment, each judgmental review queue may comprise accounts that are associated with similar identified risk patterns. Each queue may be judgmentally reviewed by different users associated with different lines of operation in the financial institution. In some embodiments, the system may prioritize the accounts, i.e., add each account to an appropriate position in a judgmental review queue based on the previously computed risk score. Therefore, one account may have a higher risk score than the other account, and consequently, the account with the higher risk score may be placed ahead of the other account on the judgmental review queue. Therefore, in such an embodiment, a user who reviews the accounts on the judgmental review queue may review the account with the higher risk score before reviewing the account with the lower risk score. In another embodiment, a risk rating may be used instead of a risk score to prioritize the accounts on a judgmental review queue. In such an embodiment, an account with a higher risk score may be placed either ahead of or behind an account with a lower risk score on a judgmental review queue because both accounts have the same risk rating.

The process then moves to block 228 of FIG. 3 where the system may present account data for each account in the judgmental review queue to a user. In one embodiment, the system may present, via a computing device processor, account data for each account on a workstation associated with the user. The workstation 50 is presented in FIG. 1 and is described in further detail below. The account data presented by the system is described in more detail below.

The process then moves to block 232 of FIG. 3 where the user may perform a judgmental review for the accounts on a judgmental review queue. In one embodiment, a judgmental review may be an analysis of an account by one or more users of the system to determine whether or not to execute one or more risk mitigation actions on the account under consideration. The objective of executing the one or more risk mitigation actions on the account may be to reduce the possible financial losses associated with the risk patterns identified for the account. In some embodiments, a judgmental review may be a holistic analysis of the account, wherein the user not only considers account data presented by the system but may also consider other data associated with the account or account holder obtained from other external sources. The account data presented by the system is described in more detail below.

The process then moves to block 236 of FIG. 3 where the user may determine whether to execute one or more risk mitigation actions or routines on the account. In one embodiment, as described below, the system may present the user with one or more recommended risk mitigation actions based at least in part on the risk patterns identified for the account. These recommended risk mitigation actions may be automatically generated by the system based on logic/routines built into the system. In one embodiment, the user may choose a risk mitigation action recommended by the system. In one embodiment, the user may design his or her own customized risk mitigation action and may enter input into the system that executes the user's customized risk mitigation action. Risk mitigation actions may include, but may not be limited to, placing a hold on a payment, or part of a payment, made to the account; decreasing a line of credit associated with the account, wherein, in some instances, a line of credit associated with the account is decreased by the amount of a payment made to the account which has not yet been collected; closing a line of credit associated with the account on a temporary basis; closing a line of credit associated with the account on a permanent basis; forcing the term out of a remaining balance in the account; blocking a transaction involving an account; blocking access of an account to a user associated with the account, wherein the blocked account cannot participate in one or more transaction; forcing a holder of an account to comply with a financial obligation associated with the account, etc. In some embodiments, a risk mitigation action may also include not executing any risk action, at all, on an account under consideration. The risk mitigation actions may not be limited to the risk mitigation actions described here.

The system may be configured to automatically execute some of the above described risk mitigation actions in response to identifying one or more risk patterns associated with an account. For instance, in response to automatically identifying a risk pattern such as a payment made to an account that has not yet been collected, the system may automatically block a transaction associated with an account such as a cash or credit advancement of an amount equal to the payment made to the account that is not yet collected. In some embodiments, the system may automatically place a hold on a payment made to the account. In some embodiments, the system may automatically decrease a line of credit associated with the account, wherein, in some instances, a line of credit associated with the account is automatically decreased by the amount of a payment made to the account until the payment is collected. In some embodiments, the system may automatically close a line of credit associated with the account on a temporary basis. In some embodiments, the system may automatically close a line of credit associated with the account on a permanent basis. In some embodiments, the system may automatically force the term out of a remaining balance in the account. In some embodiments, the system may automatically block a transaction involving an account. In some embodiments, the system may automatically block access of an account to a user associated with the account, wherein the blocked account cannot participate in one or more transactions. In some embodiments, the system may automatically force a holder of an account to comply with a financial obligation associated with account. The type of risk mitigation actions that the system may be configured to automatically execute are not limited to the risk mitigation actions described here.

Apart from the risk score or rating associated with an account, in some embodiments, the user may, in determining whether to execute a risk mitigation action on an account, consider other data including whether the account may be eligible for an override, wherein if the account is eligible for an override, a risk mitigation action is not executed for the account. In other embodiments, the user may also consider whether the loan product associated with an account is an excluded product, wherein a risk mitigation account is not executed for an account associated with an excluded product. The factors considered by the user may not be limited to factors or considerations described herein.

If the user decides not to execute one or more risk mitigation actions on an account under consideration, the user may enter input into the system at block 244 indicating that the user judgmentally reviewed the account but decided not to execute a risk mitigation action on the account. The user may also input any remarks into the system, e.g., remarks indicating the reasons for not executing a risk mitigation action on the account. The system may then take the account out of the judgmental review queue. When the system processes account updates 204 on a subsequent occasion, the system may update the account to note that the user judgmentally reviewed the account but decided not to execute a risk mitigation action on the account.

If the user decides to execute one or more risk mitigation actions on an account under consideration, the process flow may move to block 240. The system may present the user with options to execute one or more risk mitigation actions, and the user may choose to execute one of the presented options. Alternatively, the user may enter input into the system to execute a customized or user-defined risk mitigation action that is not presented as an option to the user. The user may also input any remarks into the system, e.g., remarks indicating the reasons for executing a particular risk mitigation action on the account. The system may then take the account out of the judgmental review queue. When the system processes account updates 204 on a subsequent occasion, the system may update the account to execute the risk mitigation action selected or designed by the user.

In one embodiment, when the system processes account updates at block 204, the system may not execute the risk mitigation action selected or designed by the user. The system may determine that the risk mitigation action selected by the user is not within the limit of the user's authority. In such an embodiment, the system may prompt the user to select a second user who may be able to review whether the risk mitigation action selected by the user is appropriate for the account. In other embodiments, the system may itself select a second user to review whether the risk mitigation action selected by the user is appropriate for the account. In such embodiments, the system may execute the risk mitigation action after the second user enters input into the system approving the execution of the user's selected risk mitigation action for the account. The second user may also input remarks on the account. If the second user determines that the risk mitigation action selected by the user is not appropriate for the account, the system may notify the user that the selected risk mitigation action is not appropriate for the account, and the system may allow the user to re-determine a risk mitigation action to be executed for the account. In one embodiment, the system may re-add the account to a judgmental review queue associated with the user. In another embodiment, the system may allow the user to re-determine a risk mitigation action to be executed for the account without re-adding the account onto a judgmental review queue associated with the user.

### Other Features

In one embodiment, the system may initiate and communicate an error message to a holder of an account who attempts an action in opposition to the risk mitigation action executed on the account. For instance, a holder of an account may attempt an advance on a blocked account. In response to this attempt, the system may communicate an error message to the account holder's computer who may view the message on a display screen.

As a further instance, in another embodiment, the system may initiate and communicate an error message to an account holder who attempts to access a credit line of an account in an instance where a risk mitigation action such as a payment hold is executed on an account and the credit line associated with the account is blocked. In one embodiment, this error message may be communicated to the account holder's computer who may view the message on a display screen. As a further instance, in an embodiment where the credit line associated with an account is decreased but not blocked, the system may initiate and communicate an error message to an account holder who attempts to access an amount greater than the reduced credit limit associated with the account.

In one embodiment, the system, may automatically determine that a risk pattern no longer exists on an account for which a risk mitigation action was previously executed. In such an embodiment, the system may automatically undo the previously implemented risk mitigation action. Alternatively, the system may notify a user that a previously identified risk pattern no longer exists for an account and may allow the user to determine whether or not to undo the previously implemented risk mitigation action.

For instance in one embodiment, the system, in response to determining that a risk pattern is removed, may automatically unblock a blocked account, remove a payment hold, raise a reduced credit limit associated with an account, etc., wherein each of these risk mitigation actions was previously executed in response to one or more identified risk patterns. In another embodiment, the system may notify a user that the previously identified risk pattern no longer exists for an account and may allow the user to determine any appropriate action.

In one embodiment, the system may automatically undo a previously executed risk mitigation action for an account even though the previously identified risk pattern still exists for the account. For instance, in one embodiment, the system may automatically remove, after a pre-determined period of holding time, a payment hold on a payment made to an account, regardless of whether a risk pattern has been removed and regardless of whether the payment has been cleared or collected.

### Judgmental Review Interface

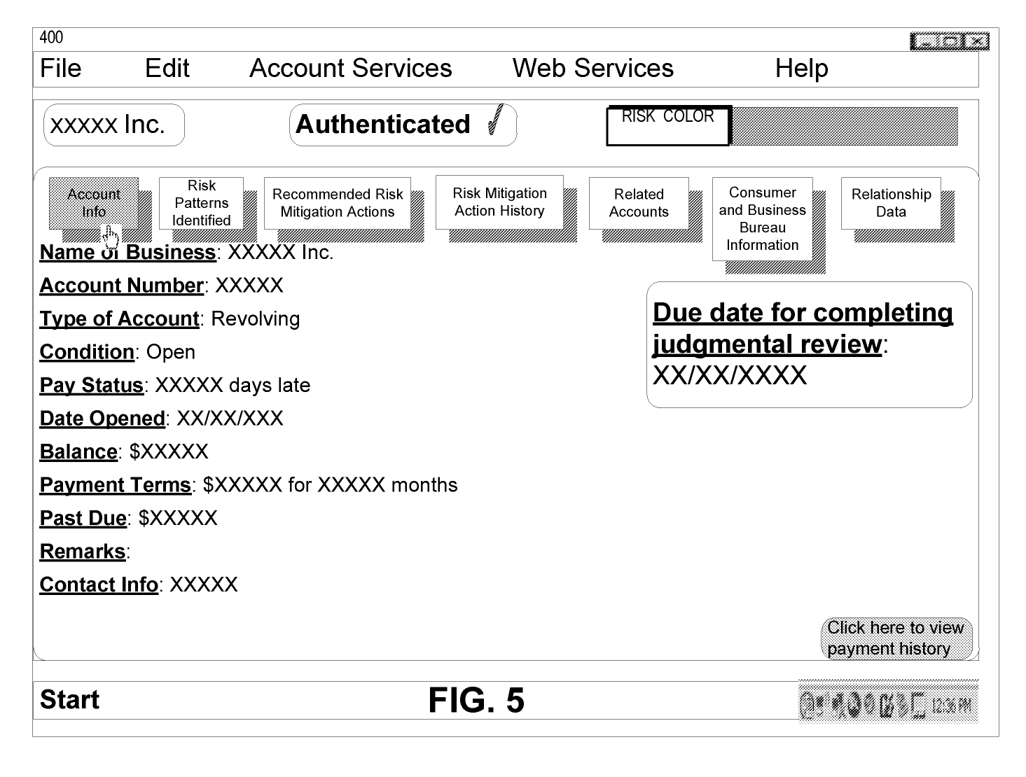

FIGS. 5-10 illustrate a graphical user interface 400 generated by the system that presents to a user account data associated with an account on a judgmental review queue. As FIG. 5 illustrates, the account data indicates the name of the account holder and the risk color associated with the identified risk pattern for the account under consideration. In other embodiments, the system may present the previously described risk score in addition to, or instead of, the risk color associated with the identified risk pattern for the account.

The risk color or score may indicate to the user the meticulousness with which a user should judgmentally review the account. For instance, in one embodiment, the computed score is standardized to a scale from 0 to 100. In such an embodiment, a computed risk score between 0 and 33 may be assigned a ‘green’ color. Further, a computed risk score between 33 and 66 may be assigned a ‘yellow’ color. Further, a computed risk score between 66 and 100 may be assigned a ‘red’ color. In one embodiment, each risk color may also be shaded based on a risk score associated with an account. In one embodiment, a user may be able to change the colors or change each range of scores that correspond to a particular color. For instance, a user may input changes into the system such that a computed risk score between 0 and 50 yields a ‘green’ color. In other embodiments, there may be more or less than three colors that correspond with risk scores between 0 and 100. For instance, if the risk color is dark ‘red’ and the risk score is 85 on a scale of 0 to 100, the user may need to expend a lot of time and effort to analyze the account data and may even need to gather data from other sources to determine the type of risk mitigation action to execute for the account. On the contrary, if the risk color is light ‘yellow’ and the risk score is 34 on a scale of 0 to 100, the user may not need to comparatively expend that much time and effort to analyze the account data. In such an instance, the user may also not need to expend any effort to gather data from other sources.

As shown in FIG. 5, under the tab for account information, the system presents the name of the business associated with the account, the account number associated with the account, the type of account, the condition of the account, the pay status of the account, the date the account was opened, the balance on the account, the unused amount associated with an account's credit line (not shown in FIG. 5), the payment terms for the account, any past due payment, any remarks on the account, and contact information for the account holder, or the like.

The account number may be a unique identification number for the account. The type of account may indicate whether the account is an installment account, a revolving account, a mortgage account, a consumer finance account, a collection account, a payroll credit account, or the like. The condition of the account may indicate whether the account is open or closed. The pay status may indicate the status of the most recent payment that was due on the account. The balance on the account indicates the total amount that is due on the account. The payment terms may indicate the amount and frequency of payments that have to be made on the account. The past due amount may indicate the amount of one or more payments that are overdue.

As indicated in FIG. 5, the system presents various tabs and button that allow the user to access various pieces of information associated with the account. For instance, in one embodiment, the system may present tabs for account information, risk patterns identified for the account, recommended risk mitigation actions for the account, risk mitigation action history, other related accounts held at the same financial institution as the account under consideration, consumer and business bureau information associated with the account or the account holder, and other relationship data regarding the account holder or the account that may be obtained through a relationship management system. The system may also present the due date for the user to complete the judgmental review of the account. In some embodiments, the system may also present a button that redirects the user to a page that presents the payment history on the account.

In one embodiment, the system may also present a button for the user to skip the judgmental review of the account under consideration and move to the judgmental review of another account on the judgmental review queue. In such an embodiment, the user may return to the skipped account in the future. In another embodiment, the system may also present a button for the user to transfer the account to another judgmental review queue, wherein accounts on the other judgmental review queue may be reviewed by another user. In some embodiments, a user may transfer the account when the user does not have the expertise to understand the particular risk patterns identified for the account under consideration.

In one embodiment, the system may also present a separate button or link to view payment history associated with the account. The payment history may indicate the amount of each past payment and the date on which each past payment was made.

In some embodiments, the system may present a link to a page that allows a user to undo any risk mitigation actions that were previously executed on an account. For instance, a user of the system may manually override a blocked account, manually remove a block on an account, manually remove a hold on a payment made to an account, manually increase a credit line associated with an account, wherein the credit line was previously decreased, etc. In another embodiment, the system may automatically undo any risk mitigation actions that were previously executed on an account when the system detects the that identified risk pattern that prompted the risk mitigation action no longer exists. Therefore, for instance, the system may automatically override a blocked account, automatically remove a block on an account, automatically remove a hold on a payment made to an account, automatically increase a credit line associated with an account, wherein the credit line was previously decreased, etc. The risk mitigation undoing or removal actions may not be limited to the risk mitigation undoing or removal actions described here.

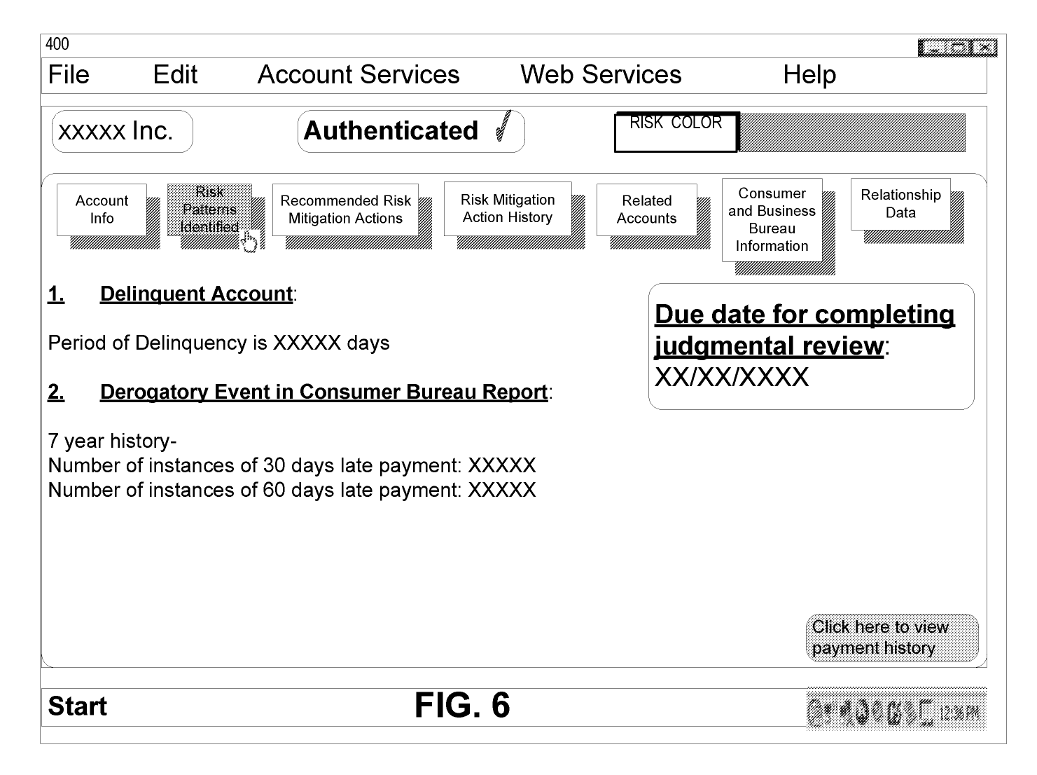

As shown in FIG. 6, under the tab for risk patterns identified by the system or by a user of the system, the system indicates that the first risk pattern is a delinquency associated with the account, wherein the period of delinquency is 35 days. The system also indicates that there is a derogatory event in the consumer bureau report. As indicated in FIG. 6, in the preceding seven years, a holder associated with the account has had two instances of delinquency where the holder of the account made a payment on a bill at least thirty dates past the due date and two instances of delinquency where the holder of the account made a payment on a bill at least sixty days past the due date.

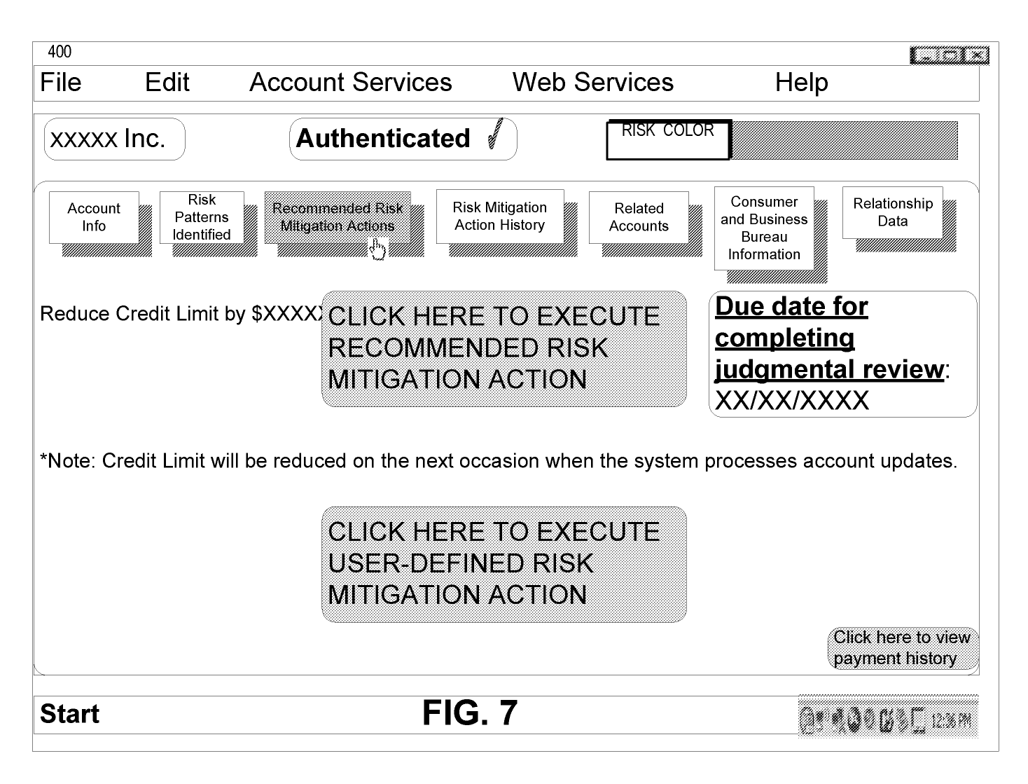

As shown in FIG. 7, under the tab for recommended risk mitigation actions, the system presents a recommended risk mitigation action. This recommended risk mitigation action may be based, at least in part, on the risk pattern identified for the account. The system may present an activatable button that allows a user of the system to execute the recommended risk mitigation action. The system may also notify the user that the risk mitigation executed by the user will not be executed until the next occasion when the system processes account updates. The system may also provide an activatable button for a user that re-directs the user to an interface page where the user may input a user-defined risk mitigation action. In some instances, the system might even recommend to the user to not execute a risk mitigation action on the account under consideration.

The system may also allow the user to initiate communication of notification of the risk mitigation action to a holder of the account. For instance, the graphical user interface may present an activatable button that redirects the user to an interface page where the user may enter input regarding the type of risk mitigation action executed on the account and the steps the account holder may need to take in order to restore the original privileges associated with the account. For instance, if a credit limit associated with an account has been decreased because of a delinquent payment, a holder of the account may be able to increase the credit limit of the account by making a pre-determined number of on-time payments. Subsequently, the system may also present one or more contact options (mail, electronic mail, voicemail, SMS (short message service), etc.), and the user may select one or more contact options to communicate the notification of the risk mitigation action to the holder of the account. In an alternate embodiment, the system may automatically initiate communication of notification of the risk mitigation action to a holder of the account via one or more contact options.

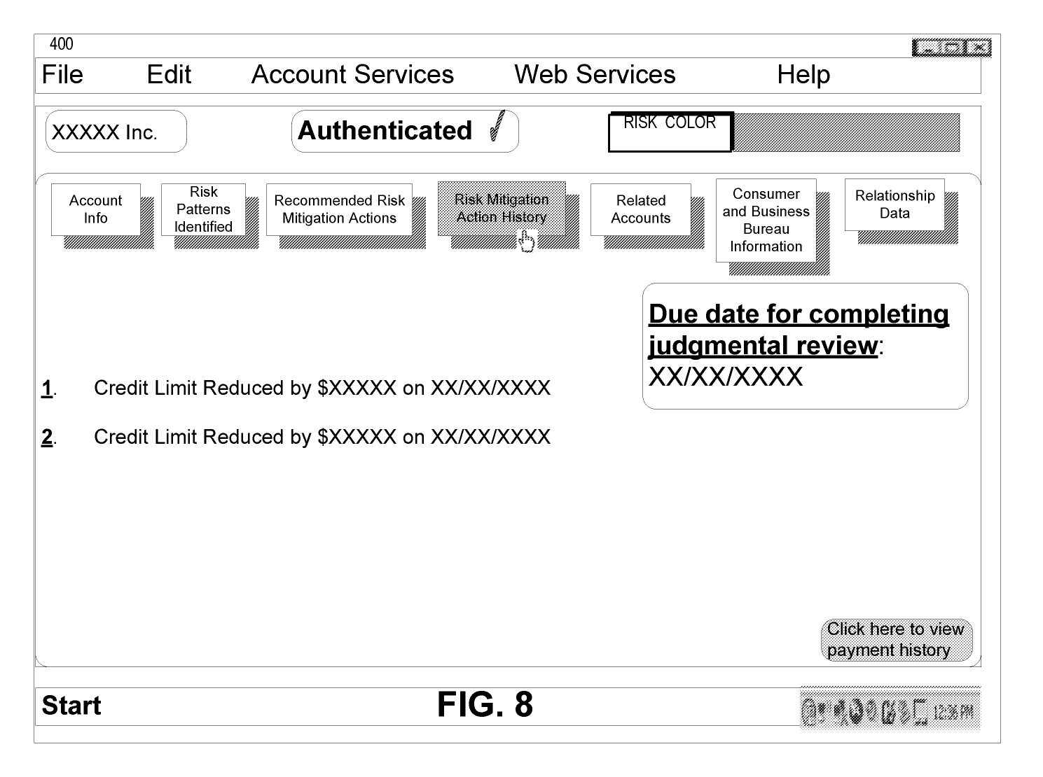

As shown in FIG. 8, under the tab for risk mitigation action history, the system presents two instances when risk mitigation actions were executed on the account. In the first instance, a credit limit associated with the account was reduced by $42000, and in the second instance, a credit limit associated with the account was reduced by $15000. Both these instances of credit limit reductions may have been executed by a user who completed judgmental reviews on the account on the dates of the credit limit reductions. Alternatively, these instances of credit limit reductions may have been automatically executed by the system in response to identifying one or more risk patterns. As a further instance, in an embodiment where a payment hold was previously executed on an account, the system may present the amount of the payment hold and the payment hold expiration date.

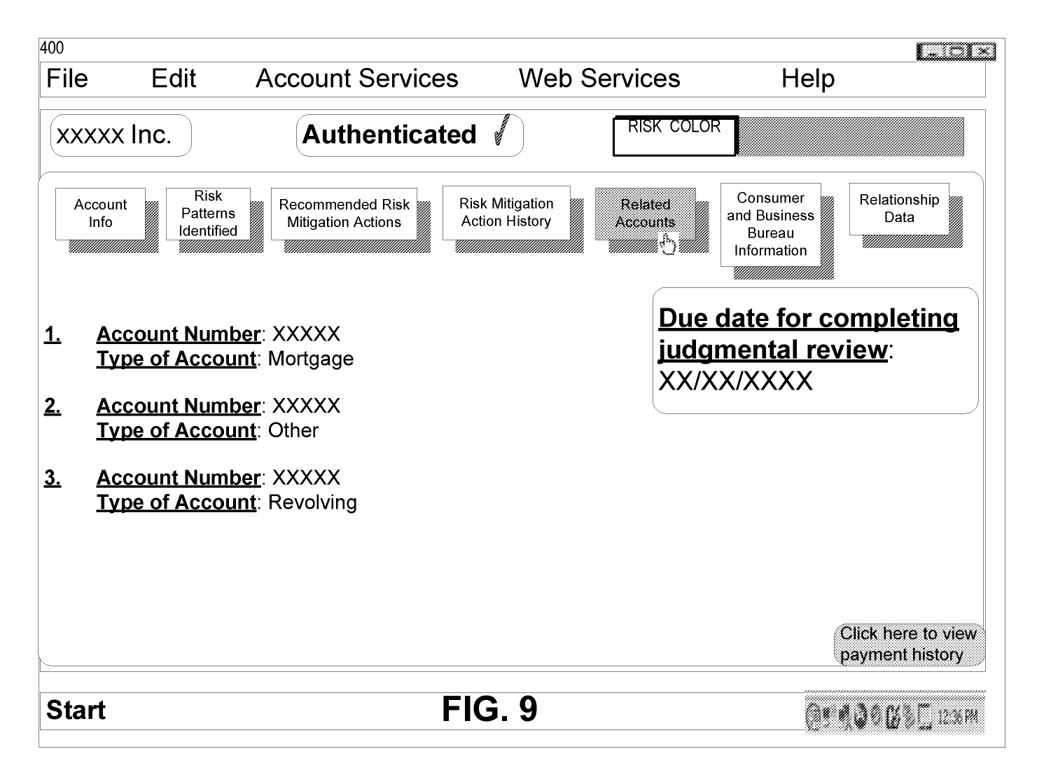

As shown in FIG. 9, under the tab for related accounts, the system presents other accounts associated with the holder of the account under consideration. These other associated accounts may be managed or held at the same financial institution that manages or holds the account under consideration. As indicated in FIG. 9, the system may display the account number and type of account for each associated account. In some embodiments, the account number may be clickable so that when a user clicks on the account number, the system redirects the user to an interface page that comprises details of the associated account. The details of the associated account may be presented on a graphical user interface similar to the graphical user interface presented for the account under consideration in FIG. 5.

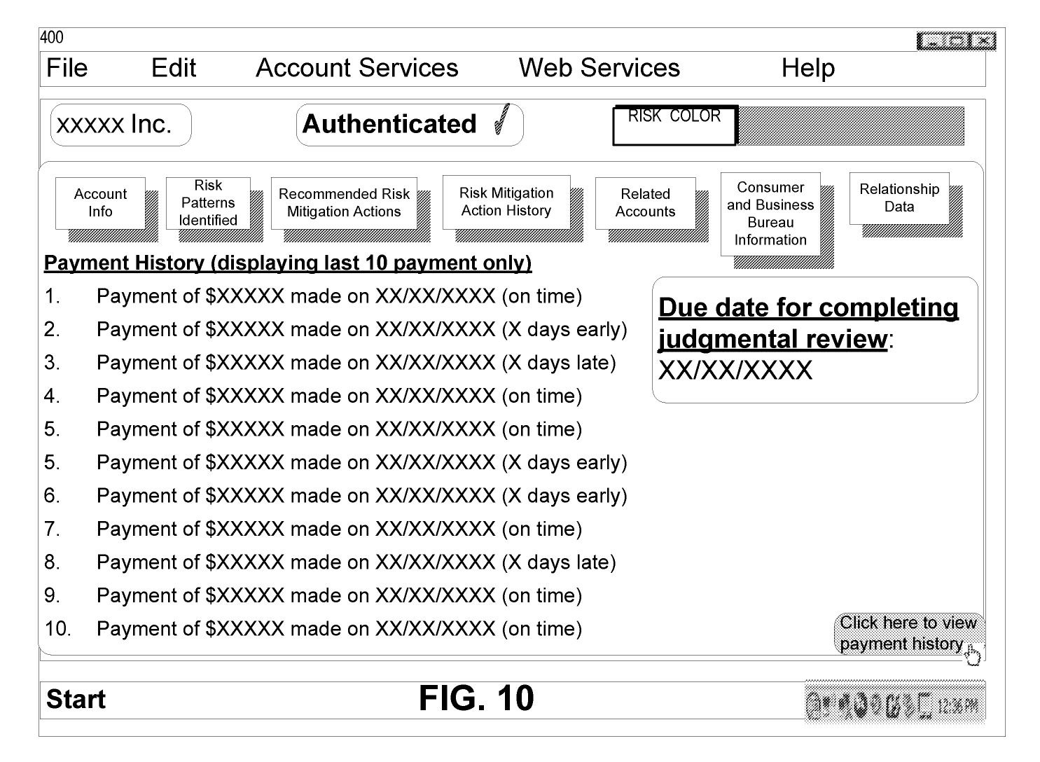

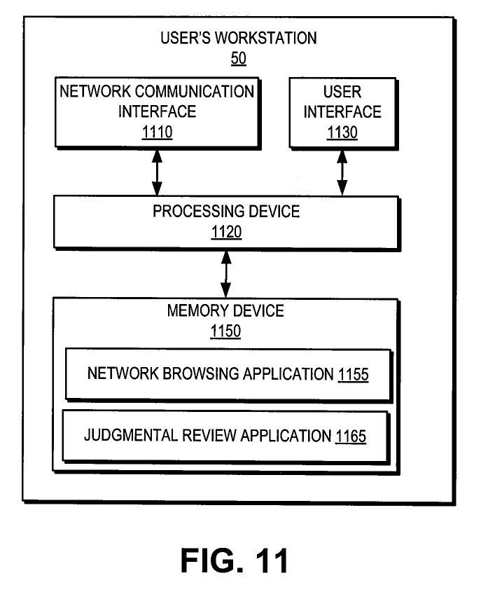

As shown in FIG. 10, when a user activates the button to view payment history associated with the account, the system presents the previous ten payment amounts along with the date that each payment was made. The system may also present whether each payment was made early, on time, or late. Although there appear to be two instances of late payment as shown in FIG. 10, FIG. 8 does not show that these instances of late payment caused one or more risk mitigation actions to be executed on the account. One reason may be that since the periods of delinquency on each payment were only two and six days, respectively, these periods of delinquency did not trigger unfavorable risk ratings that would have caused the account to be placed on a judgmental review queue in both instances. Alternatively, in both instances of delinquency, the account may have been placed on a judgmental review queue, but a user of the system may have decided not to execute a risk mitigation action on the account after completing a judgmental review of the account.

### Alternative Embodiments

In some embodiments, in response to identifying a risk pattern for an account, the system may not add the account to a judgmental review queue. Instead, the system may generate a risk alert for the account. The system may also generate a risk alert for an account when a risk pattern associated with an account ceases to exist.

In one embodiment, a risk alert may be an electronic file. The risk alert logic/routine may be incorporated into block 107 in FIG. 2. In one embodiment, a risk alert may be generated dynamically and sent immediately, via a computing device processor and via communication methods described earlier, to an appropriate user when a risk pattern is identified for an account, or when a risk pattern ceases to exist for an account. The appropriate user may pursue further review or investigation of the account.

In one embodiment, the system may include in separate periodic, e.g., daily, electronic notices to each client manager, the client manager's accounts associated with risk patterns that have either been identified for those accounts or were previously identified and now cease to exist for those accounts.

The system may also allow a user to query an account to determine whether the account satisfies a risk pattern. The query logic/routine is represented by block 108 in FIG. 2. In one embodiment, the system may also allow a user to query more than one account in the same query. In one embodiment, the system may also allow a user to customize the risk identification rules in his or her queries in order to determine whether the queried account poses a risk based on the customized risk identification rules. The system may electronically deliver, according the embodiments described above, the results of the query to the recipient specified in the query, and allow the recipient to view the results of a query via an electronic display associated with the recipient.

### Embodiment of Workstation that Presents Judgmental Review Interface to User

The workstation 50 of FIG. 1 presents the judgmental review interface to the user 20. The workstation may include various features, such as a network communication interface 1110, a processing device 1120, a user interface 1130, and a memory device 1150.

As used with respect to the workstation, a “communication interface” may generally include a modem, server, transceiver, and/or other device for communicating with other devices on a network. The network communication interface may be a communication interface having one or more communication devices configured to communicate with one or more other devices on the network 55, such as the account holder's computing device, the system 12, other processing systems, data systems, etc.

As used with respect to the workstation, a “processing device” may generally refer to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device may be configured to use the network communication interface to transmit and/or receive data and/or commands to and/or from the other devices connected to the network.

As used with respect to the workstation, a “user interface” may generally include a plurality of interface devices and/or software that allow a user to input commands and data to direct the processing device to execute instructions. For example, the user interface may include a graphical user interface (GUI) or an interface to input computer-executable instructions that direct the processing device to carry out specific functions. The user interface may employ certain input and output devices to input data received from the user or output data to the user. These input and output devices may include a display, mouse, keyboard, button, touchpad, touch screen, microphone, speaker, light, joystick, switch, and/or other customer input/output device for communicating with one or more customers. As used with respect to the workstation, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein. In one embodiment, the memory device may include a network browsing application 1155 through which the user may access the judgmental review interface. In another embodiment, the memory device may include a judgmental review application 1165 which presents the judgmental review interface.

Thus, present embodiments disclosed in detail above provide systems, methods and computer program products for identifying one or more risk patterns for an account based on a plurality of rules, determining whether to add an account on to a judgmental review queue based at least in part on the one or more risk patterns identified for the account, and allowing a user to execute one or more risk mitigation actions for the account in order to curb possible financial losses that may result from the identified risk patterns.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for risk identification and mitigation at a system, the method comprising:
periodically receiving, via a computing device processor, account data for an account;
identifying, via a computing device processor, a risk pattern associated with the account;
in response to identifying a risk pattern associated with the account, determining, via a computing device processor, whether the account was reviewed by a user within a pre-determined period in the past; and
in response to determining that the account was not reviewed by a user within the pre-determined period in the past, adding, via a computing device processor, the account to a judgmental review queue.

2. The method of claim 1, further comprising:
presenting to a user, via a computing device processor, account data associated with the account;
allowing the user to determine, via a computing device processor, whether a risk mitigation action needs to be executed on the account; and
allowing the user to determine, via a computing device processor, the type of risk mitigation action to be executed on the account.

3. The method of claim 1, wherein identifying a risk pattern comprises:
determining, via a computing device processor, whether the account is late on a payment, wherein the account is late on the payment if the payment on the account has been due for a pre-determined period of time.

4. The method of claim 1, wherein identifying a risk pattern comprises:
determining, via a computing device processor, whether a risk mitigation action was executed on the account within a pre-determined period of time in the past.

5. The method of claim 1, wherein identifying a risk pattern comprises:
accessing, via a computing device processor, a second account associated with the account; and
determining, via a computing device processor, whether the second account is late on a payment, wherein the second account is late on the payment if the payment on the second account has been due for a pre-determined period of time.

6. The method of claim 1, wherein identifying a risk pattern comprises:
accessing, via a computing device processor, a business bureau report associated with the account; and
determining, via a computing device processor, whether there is a derogatory event in the business bureau report.

7. The method of claim 1, wherein identifying a risk pattern comprises:
accessing, via a computing device processor, a consumer bureau report associated with the account; and
determining, via a computing device processor, whether there is a derogatory event in the consumer bureau report.

8. The method of claim 1, wherein identifying a risk pattern comprises:
determining, via a computing device processor, a score associated with the identified risk pattern;
determining, via a computing device processor, a rating associated with the identified risk pattern based at least in part on the score; and
determining, via a computing device processor, whether the rating associated with the account is favorable.

9. The method of claim 2, wherein presenting further comprises:
pictorially presenting, via a computing device processor, a rating associated with the identified risk pattern.

10. The method of claim 9, wherein the rating is a color.

11. The method of claim 2, wherein presenting further comprises:
presenting, via a computing device processor, account data associated with the account;
presenting, via a computing device processor, the one or more risk patterns identified for the account; and
presenting, via a computing device processor, one or more suggested risk mitigation actions for the account, based at least in part on the one or more risk patterns identified for the account.

12. The method of claim 2, wherein the risk mitigation action comprises:
placing, via a computing device processor, a hold on a payment made to the account.

13. The method of claim 2, wherein the risk mitigation action comprises:
decreasing, via a computing device processor, a line of credit associated with the account.

14. The method of claim 2, wherein the risk mitigation action comprises:
closing, via a computing device processor, a line of credit associated with the account.

15. The method of claim 2, wherein the risk mitigation action comprises:
blocking, via a computing device processor, access of an account to a holder of the account, wherein the blocked account cannot participate in one or more transactions.

16. The method of claim 2, wherein the risk mitigation action comprises:
forcing, via a computing device processor, a holder of the account to comply with a financial obligation associated with the account.

17. The method of claim 2, further comprising:
prioritizing, via a computing device processor, accounts in the judgmental review queue, such that account data for an account with a higher risk score is presented to the user before account data for an account with a lower risk score.

18. The method of claim 2, further comprising:
in response to the user determining a risk mitigation action to be executed for an account, allowing the user, via a computing device processor, to initiate notification of the risk mitigation action to a holder of the account.

19. The method of claim 2, further comprising:
determining, via a computing device processor, whether executing the risk mitigation action is within a limit of the user's authority; and
in response to determining that executing the risk mitigation action is not within the limit of the user's authority, prompting the user, via a computing device processor, to select a second user.

20. The method of claim 19, wherein, in lieu of prompting the user to select a second user, automatically determining, via a computing device processor, a second user.

21. The method of claim 20, further comprising:
allowing a second user, via a computing device processor, to determine whether executing the risk mitigation action is appropriate;
in response to the second user determining the risk mitigation action is not appropriate, allowing the user, via a computing device processor, to re-determine, via a computing device processor, a risk mitigation action to be executed on the account; and
in response to the second user determining the risk mitigation action is appropriate, executing, via a computing device processor, the risk mitigation action.

22. An apparatus for risk identification and mitigation at a system, the apparatus comprising:
a computing platform including at least one computing device processor and a memory;
a module stored in the memory, executable by a computing device processor, and configured to:
periodically receive, via a computing device processor, account data for an account;
identify, via a computing device processor, a risk pattern associated with the account;
in response to identifying a risk pattern associated with the account, determine, via a computing device processor, whether the account was reviewed by a user within a pre-determined period in the past; and
in response to determining that the account was not reviewed by a user within the pre-determined period in the past, add, via a computing device processor, the account to a judgmental review queue.

23. The apparatus of claim 22, wherein the module is further configured to:
present to a user, via a computing device processor, account data associated with the account;
allow the user to determine, via a computing device processor, whether a risk mitigation action needs to be executed on the account; and
allow the user to determine, via a computing device processor, the type of risk mitigation action to be executed on the account.

24. The apparatus of claim 22, wherein the module configured to identify a risk pattern is further configured to:
determine, via a computing device processor, whether the account is late on a payment, wherein the account is late on the payment if the payment on the account has been due for a pre-determined period of time.

25. The apparatus of claim 22, wherein the module configured to identify a risk pattern is further configured to:
determine, via a computing device processor, whether a risk mitigation action was executed on the account within a pre-determined period of time in the past.

26. The apparatus of claim 22, wherein the module configured to identify a risk pattern is further configured to:
access, via a computing device processor, a second account associated with the account; and
determine, via a computing device processor, whether the second account is late on a payment, wherein the second account is late on the payment if the payment on the second account has been due for a pre-determined period of time.

27. The apparatus of claim 22, wherein the module configured to identify a risk pattern is further configured to:
access, via a computing device processor, a business bureau report associated with the account; and
determine, via a computing device processor, whether there is a derogatory event in the business bureau report.

28. The apparatus of claim 22, wherein the module configured to identify a risk pattern is further configured to:
access, via a computing device processor, a consumer bureau report associated with the account; and
determine, via a computing device processor, whether there is a derogatory event in the consumer bureau report.

29. The apparatus of claim 22, wherein the module configured to identify a risk pattern is further configured to:
determine, via a computing device processor, a score associated with the identified risk pattern;
determine, via a computing device processor, a rating associated with the identified risk pattern based at least in part on the score; and
determine, via a computing device processor, whether the rating associated with the account is favorable.

30. The apparatus of claim 23, wherein the module configured to present account data is further configured to:
pictorially present, via a computing device processor, the rating associated with the identified risk pattern.

31. The apparatus of claim 30, wherein the rating is a color.

32. The apparatus of claim 23, wherein the module configured to present account data is further configured to:
present, via a computing device processor, account data associated with the account;
present, via a computing device processor, the one or more risk patterns identified for the account; and
present, via a computing device processor, one or more suggested risk mitigation actions for the account, based at least in part on the one or more risk patterns identified for the account.

33. The apparatus of claim 23, wherein the risk mitigation action comprises:
the module configured to place, via a computing device processor, a hold on a payment made to the account.

34. The apparatus of claim 23, wherein the risk mitigation action comprises:
the module configured to decrease, via a computing device processor, a line of credit associated with the account.

35. The apparatus of claim 23, wherein the risk mitigation action comprises:
the module configured to close, via a computing device processor, a line of credit associated with the account.

36. The apparatus of claim 23, wherein the risk mitigation action comprises:
the module configured to block, via a computing device processor, access of an account to a holder of the account, wherein the blocked account cannot participate in one or more transactions.

37. The apparatus of claim 23, wherein the risk mitigation action comprises:
the module configured to force, via a computing device processor, a holder of the account to comply with a financial obligation associated with the account.

38. The apparatus of claim 23, wherein the module is further configured to:
prioritize, via a computing device processor, accounts in the judgmental review queue, such that account data for an account with a higher risk score is presented to the user before account data for an account with a lower risk score.

39. The apparatus of claim 23, wherein the module is further configured to:
in response to the user determining a risk mitigation action to be executed for an account, allow the user, via a computing device processor, to initiate notification of the risk mitigation action to a holder of the account.

40. The apparatus of claim 23, wherein the module is further configured to:
determine, via a computing device processor, whether executing the risk mitigation action is within a limit of the user's authority; and
in response to determining that executing the risk mitigation action is not within the limit of the user's authority, prompt the user, via a computing device processor, to select a second user.

41. The apparatus of claim 40, wherein, in lieu of the module configured to prompt the user to select a second user, the module configured to automatically determine, via a computing device processor, a second user.

42. The apparatus of claim 41, wherein the module is further configured to:
allow a second user, via a computing device processor, to determine whether executing the risk mitigation action is appropriate;
in response to the second user determining the risk mitigation action is not appropriate, allow the user, via a computing device processor, to re-determine, via a computing device processor, a risk mitigation action to be executed on the account; and
in response to the second user determining the risk mitigation action is appropriate, execute, via a computing device processor, the risk mitigation action.

43. A computer program product for risk identification and mitigation at a system, the computer program product comprising:
a non-transitory computer-readable medium comprising a set of codes for causing a computer to:
periodically receive, via a computing device processor, account data for an account;
identify, via a computing device processor, a risk pattern associated with the account;
in response to identifying a risk pattern associated with the account, determine, via a computing device processor, whether the account was reviewed by a user within a pre-determined period in the past; and
in response to determining that the account was not reviewed by a user within the pre-determined period in the past, add, via a computing device processor, the account to a judgmental review queue.

44. The computer program product of claim 43, wherein the set of codes further causes a computer to:
present to a user, via a computing device processor, account data associated with the account;
allow the user to determine, via a computing device processor, whether a risk mitigation action needs to be executed on the account; and
allow the user to determine, via a computing device processor, the type of risk mitigation action to be executed on the account.

45. The computer program product of claim 43, wherein the set of codes causing a computer to identify a risk pattern further causes a computer to:
determine, via a computing device processor, whether the account is late on a payment, wherein the account is late on the payment if the payment on the account has been due for a pre-determined period of time.

46. The computer program product of claim 43, wherein the set of codes causing a computer to identify a risk pattern further causes a computer to:
determine, via a computing device processor, whether a risk mitigation action was executed on the account within a pre-determined period of time in the past.

47. The computer program product of claim 43, wherein the set of codes causing a computer to identify a risk pattern further causes a computer to:
access, via a computing device processor, a second account associated with the account; and
determine, via a computing device processor, whether the second account is late on a payment, wherein the second account is late on the payment if the payment on the second account has been due for a pre-determined period of time.

48. The computer program product of claim 43, wherein the set of codes causing a computer to identify a risk pattern further causes a computer to:
access, via a computing device processor, a business bureau report associated with the account; and
determine, via a computing device processor, whether there is a derogatory event in the business bureau report.

49. The computer program product of claim 43, wherein the set of codes causing a computer to identify a risk pattern further causes a computer to:
access, via a computing device processor, a consumer bureau report associated with the account; and
determine, via a computing device processor, whether there is a derogatory event in the consumer bureau report.

50. The computer program product of claim 43, wherein the set of codes causing a computer to identify a risk pattern further causes a computer to:
determine, via a computing device processor, a score associated with the identified risk pattern;
determine, via a computing device processor, a rating associated with the identified risk pattern based at least in part on the score; and
determine, via a computing device processor, whether the rating associated with the account is favorable.

51. The computer program product of claim 44, wherein set of codes causing a computer to present account data further causes a computer to:
pictorially present, via a computing device processor, a rating associated with the identified risk pattern.

52. The computer program product of claim 51, wherein the rating is a color.

53. The computer program product of claim 44, wherein set of codes causing a computer to present account data further causes a computer to:
present, via a computing device processor, account data associated with the account;
present, via a computing device processor, the one or more risk patterns identified for the account; and
present, via a computing device processor, one or more suggested risk mitigation actions for the account, based at least in part on the one or more risk patterns identified for the account.

54. The computer program product of claim 44, wherein the risk mitigation action comprises:
the set of codes causing a computer to place, via a computing device processor, a hold on a payment made to the account.

55. The computer program product of claim 44, wherein the risk mitigation action comprises:
the set of codes causing a computer to decrease, via a computing device processor, a line of credit associated with the account.

56. The computer program product of claim 44, wherein the risk mitigation action comprises:
the set of codes causing a computer to close, via a computing device processor, a line of credit associated with the account.

57. The computer program product of claim 44, wherein the risk mitigation action comprises:
the set of codes causing a computer to block, via a computing device processor, access of an account to a holder of the account, wherein the blocked account cannot participate in one or more transactions.

58. The computer program product of claim 44, wherein the risk mitigation action comprises:
the set of codes causing a computer to force, via a computing device processor, a holder of the account to comply with a financial obligation associated with the account.

59. The computer program product of claim 44, wherein the set of codes further causes a computer to:
prioritize, via a computing device processor, accounts in the judgmental review queue, such that account data for an account with a higher risk score is presented to the user before account data for an account with a lower risk score.

60. The computer program product of claim 44, wherein the set of codes further causes a computer to:
in response to the user determining a risk mitigation action to be executed for an account, allow the user, via a computing device processor, to initiate notification of the risk mitigation action to a holder of the account.

61. The computer program product of claim 44, wherein the set of codes further causes a computer to:
determine, via a computing device processor, whether executing the risk mitigation action is within a limit of the user's authority; and
in response to determining that executing the risk mitigation action is not within the limit of the user's authority, prompt the user, via a computing device processor, to select a second user.

62. The computer program product of claim 61, wherein, in lieu of the set of codes causing a computer to prompt the user to select a second user, the set of codes causing a computer to automatically determine, via a computing device processor, a second user.

63. The computer program product of claim 62, wherein the set of codes further causes a computer to:
allow a second user, via a computing device processor, to determine whether executing the risk mitigation action is appropriate;
in response to the second user determining the risk mitigation action is not appropriate, allow the user, via a computing device processor, to re-determine, via a computing device processor, a risk mitigation action to be executed on the account; and
in response to the second user determining the risk mitigation action is appropriate, execute, via a computing device processor, the risk mitigation action.
